(19) United States
(12) Patent Application Publication
(10) Pub. No.: US 2014/0339037 A1
(43) Pub. Date: Nov. 20, 2014

(54) VIBRATION-DAMPING SHEET

(71) Applicant: NITTO DENKO CORPORATION, Osaka (JP)

(72) Inventor: Yasuhiko Kawaguchi, Osaka (JP)

(73) Assignee: NITTO DENKO CORPORATION, Osaka (JP)

(21) Appl. No.: 14/375,366

(22) PCT Filed: Mar. 1, 2013
(86) PCT No.: PCT/JP2013/055669

§ 371 Date: Jul. 29, 2014

(30) Foreign Application Priority Data
Mar. 5, 2012 (JP) 2012-047748

(51) Int. Cl. F16F 7/108

(52) U.S. Cl. CPC F16F 7/108
USPC 188/380

(57) ABSTRACT

A vibration-damping sheet includes a vibration-damping layer containing 100 parts by mass of rubber and 30 parts by mass or more of carbon black. The iodine adsorption number of the carbon black measured based on BS K6217-1 (2008) “Part 1: Determination of iodine adsorption number (Titrimetric method)” is 30 mg/g or more.

### TECHNICAL FIELD

The present invention relates to a vibration-damping sheet. In particular, the present invention relates to a vibration-damping sheet used by bonding the sheet to a vibrating member used in various industrial products.

### BACKGROUND ART

Conventionally, various components used in the field of automobiles, railroad cars, home electric appliances, office equipment, household equipment, or working machinery easily cause vibrating sounds during its operation. Therefore, it has been known that, for example, by bonding a vibration-damping sheet to the component (vibrating member) to prevent generation of the vibrating sounds, vibration-damping characteristics for the component are improved.

For example, Patent Document 1 below has proposed a vibration-damping sheet containing 100 parts of butyl rubber and 1600 parts of calcium carbonate to achieve excellent vibration-damping properties under a temperature of about 40° C.

### CITATION LIST

### Patent Document

Patent Document 1

Japanese Unexamined Patent Publication No. H9-136998

### SUMMARY OF THE INVENTION

### Problem to be Solved by the Invention

In Patent Document 1 above, vibration-damping characteristics of a vibration-damping sheet under a normal temperature (about 20° C.) and under a temperature of about 40° C. are evaluated.

Meanwhile, recently, improvement in vibration-damping characteristics are desired in components (high temperature component) used under a high temperature of more than 40° C., to be specific, heat-generating components such as motors, heaters, and engines, and furthermore, components used under a wide range of temperature from a normal temperature to a high temperature.

However, with the above-described vibration-damping sheet of Patent Document 1, there may be a case where sufficient improvement in vibration-damping characteristics of the above-described component is difficult under a wide range of temperature of the above-described normal temperature to high temperature.

An object of the present invention is to provide a vibration-damping sheet in which vibration-damping characteristics are further improved under a wide range of temperature from a normal temperature to a high temperature.

### Means for Solving the Problem

A vibration-damping sheet of the present invention includes a vibration-damping layer containing 100 parts by mass of rubber and 30 parts by mass or more of carbon black, wherein the iodine adsorption number of the carbon black measured based on JIS K6217-1 (2008) “Part 1: Determination of iodine adsorption number (Titrimetric method)” is 30 mg/g or more.

In the vibration-damping sheet of the present invention, it is preferable that 7 to 30 mass % of the carbon black is blended relative to the vibration-damping layer.

In the vibration-damping sheet of the present invention, it is preferable that, when the thickness of the vibration-damping sheet is 2.0 mm, the vibration-damping layer has a glass transition temperature of 0° C. or less, the glass transition temperature being defined as a temperature at a peak of a shear loss modulus G″ measured by dynamic viscoelasticity measurement at a frequency of 1 Hz.

In the vibration-damping sheet of the present invention, it is preferable that the vibration-damping sheet has a 90 degree peel pressure-adhesion of 10 N/25 mm or more when the vibration-damping sheet is bonded to a stainless steel plate and then peeled at 90 degree relative to the stainless steel plate at 23° C. and at a speed of 300 mm/min.

It is preferable that the vibration-damping sheet of the present invention further includes a constraining layer laminated onto the vibration-damping layer.

### Effect of the Invention

The vibration-damping sheet of the present invention includes a vibration-damping layer containing rubber and carbon black having an iodine adsorption number within a specific range in a specific mixing ratio.

Thus, by bonding the vibration-damping sheet of the present invention to a vibrating member, sufficient vibration damping can be achieved even if the vibrating member is used under a wide range of temperature from a normal temperature to a high temperature.

### BRIEF DESCRIPTION OF THE DRAWINGS

FIG. 1 is a diagram illustrating a method for bonding a vibration-damping sheet in one embodiment of the present invention to a vibrating member,

FIG. 1 (a) illustrating a step of preparing a vibration-damping sheet, and releasing a releasing paper; and

FIG. 1 (b) illustrating a step of bonding the vibration-damping sheet to the vibrating member.

### EMBODIMENT OF THE INVENTION

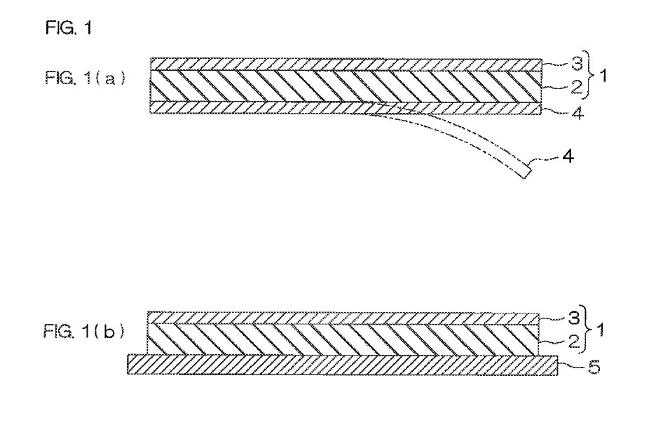

FIG. 1 is a diagram illustrating a method for bonding a vibration-damping sheet in one embodiment of the present invention to a vibrating member,

(a) illustrating a step of preparing a vibration-damping sheet, and releasing a releasing paper; and (b) illustrating a step of bonding the vibration-damping sheet to the vibrating member.

In FIG. 1 (a), the vibration-damping sheet 1 includes a vibration-damping layer 2, and a constraining layer 3 laminated on the vibration-damping layer 2.

The vibration-damping layer 2 is formed from a vibration-damping composition into a sheet.

The vibration-damping composition contains rubber and carbon black.

Examples of rubber include a high molecular weight, solid or semisolid rubber such as butyl rubber, acrylic rubber, silicone rubber, urethane rubber, vinylalkylether rubber, polyvinyl alcohol rubber, polyvinyl pyrrolidone rubber, polyacrylamide rubber, cellulose rubber, natural rubber, butadiene rubber, chloroprene rubber, styrene-isoprene rubber, styrene-butadiene rubber, acrylonitrile-butadiene rubber, styrene-ethylene-butadiene-styrene rubber, styrene-isoprene-styrene rubber, isoprene rubber, styrene-butadiene-styrene rubber, and polyisobutylene.

These examples of rubber can be used singly, or can be used in combination.

Of these examples of rubber, in view of adhesiveness and vibration-damping characteristics, preferably, butyl rubber is used.

Butyl rubber is a synthetic rubber obtained by copolymerization of isobutene (isobutylene) with isoprene.

The butyl rubber has a degree of unsaturation of, for example, 0.8 to 2.2, preferably 1.0 to 2.0.

The rubber has a Mooney viscosity (ML1+8, at 125° C.) of, for example, 25 to 90, preferably, 30 to 60.

The mixing ratio of the rubber relative to the vibration-damping composition is, for example, 5 to 70 mass %, preferably 10 to 50 mass %.

Examples of carbon black include furnace black, acetylene black, Ketjen Black, channel black, thermal black, and carbon nanotube.

Of these examples of carbon black, preferably, furnace black is used.

Examples of furnace black include SAF, ISAF, HAF, MAF, and FEF.

Of these examples of furnace black, preferably, SAF, ISAF, and HAF are used.

The shape of carbon black is not particularly limited, and for example, the shape may be generally spherical, generally needle shape, generally plate shape, and generally tubular.

The average value of the maximum length (when carbon black is generally spherical, the average particle size) of carbon black is, for example, 60 nm or less, preferably, 50 nm or less, even more preferably, 35 nm or less, and for example, 10 nm or more.

The average value of the maximum length of carbon black is calculated based on arithmetic average particle size based on volume obtained by particle size distribution analysis by laser scattering method.

The iodine adsorption number of carbon black is 30 mg/g or more, preferably 40 mg/g or more, even more preferably 60 mg/g or more, particularly preferably 80 mg/g or more, and for example, 500 mg/g or less.

The iodine adsorption number of carbon black is measured based on JIS K6217-1 (2008) “Part 1: Determination of iodine adsorption number (Titrimetric method)”.

The iodine adsorption number of carbon black is correlated with the specific surface area of carbon black. To be specific, the iodine adsorption number has a proportional relationship with the specific surface area of carbon black.

When the iodine adsorption number is smaller than the above-described lower limit value, the specific surface area of carbon black cannot be ensured sufficiently, and thus the vibration-damping sheet 1 may not achieve sufficient vibration-damping characteristics under a wide range of temperature.

These examples of carbon black can be used singly, or a plural number of these can be used in combination.

The mixing ratio of the carbon black relative to 100 parts by mass of the rubber is, 30 parts by mass or more, preferably 40 parts by mass or more, even more preferably, 75 parts by mass or more, and for example, 200 parts by mass or less. The mixing ratio of the carbon black relative to the vibration-damping composition (that is, vibration-damping layer 2) is, for example, 7 to 30 mass %, preferably 10 to 25 mass %.

When the mixing ratio of the carbon black is below the above-described lower limit value, sufficient vibration-damping characteristics may not be ensured. Furthermore, when the mixing ratio of carbon black is more than the above-described upper limit value, adhesion of the vibration-damping layer 2 is reduced, and the vibration-damping sheet 1 may not be reliably bonded to the vibrating member 5 (described later, ref: FIG. 1 (b)).

The vibration-damping composition may also contain known additives such as the following in a suitable proportion in addition to the above-described components: softeners, tackifiers, fillers (excluding carbon black), antioxidants, and furthermore, cross-linking agents, cross-linking accelerators, foaming agents, lubricants, thixotropic agents (e.g., montmorillonite, etc.), oils and fats (e.g., animal oils and fats, vegetable oils and fats, mineral oil, etc.), pigments, antiscorch agents, stabilizers, plasticizers, ultraviolet absorbers, and antifungal agents.

The softener is blended as necessary to the vibration-damping composition, and in view of handleability of the vibration-damping layer 2, for example, the following are used: oils such as paraffin oils and naphthene oils; low molecular-weight liquid rubber such as liquid polybutenes; and esters such as phthalic acid esters and phosphoric acid esters.

These softeners can be used singly, or can be used in combination.

Of these softeners, preferably, liquid polybutenes are used.

The liquid polybutene has a kinetic viscosity at 40° C. of, for example, 10 to 200000 mm²/s, preferably 1000 to 100000 mm²/s, and a kinetic viscosity at 100° C. of, for example, 2.0 to 4000 mm²/s, preferably 50 to 2000 mm²/s.

The mixing ratio of the softener relative to 100 parts by mass of the rubber is, for example, 10 to 150 parts by mass, preferably 30 to 120 parts by mass.

The tackifier is blended as necessary to the vibration-damping composition in view of pressure-adhesiveness of the vibration-damping layer 2, and examples thereof include rosin resins, terpene resins, coumarone-indene resins, phenol resins, phenol-formaldehyde resins, xyleneformalin resins, petroleum resins (e.g., C5 petroleum resins, C9 petroleum resins, C5/C9 petroleum resins, etc.).

These tackifiers can be used singly, or can be used in combination.

Of these tackifiers, preferably, petroleum resin is used.

The mixing ratio of the tackifier relative to 100 parts by mass of the adhesive resin is, for example, 5 to 150 parts by mass, preferably 10 to 100 parts by mass.

The filler is blended as necessary to the vibration-damping composition, and in view of reinforcement and handleability of the vibration-damping layer 2, the filler contains fire retardants. Examples of the filler include calcium carbonates (e.g., calcium carbonate heavy, etc.), talc, mica, clay, mica powder, bentonite, silica, alumina, aluminum silicates, titanium oxides, glass powder, boron nitrides, metal powder, and metal hydroxides (e.g., aluminum hydroxide, magnesium hydroxide, etc.).

These fillers may be used singly, or may be used in combination.

Of these fillers, preferably, calcium carbonates are used.

The mixing ratio of the filler relative to 100 parts by mass of the rubber is, for example, 10 to 300 parts by mass, preferably 25 to 200 parts by mass.

Examples of antioxidants include aromatic amine antioxidants (to be specific, aromatic secondary amine antioxidants such as 4,4′-bis(α,α-dimethylbenzyl) diphenylamine, etc.), phenol antioxidants, and imidazole antioxidants.

These antioxidants may be used singly, or may be used in combination.

Of these antioxidants, preferably, aromatic amine antioxidants are used.

The mixing ratio of the antioxidant relative to 100 parts by mass of the rubber is, for example, 0.5 to 10 parts by mass, preferably 1 to 5 parts by mass.

Of the additives, by containing a softener, a tackifier, a filler, and an antioxidant in the vibration-damping composition, the glass transition temperature of the vibration-damping layer 2 can be set to a desired range (described later).

The mixing ratios of the three additives of the softener, tackifier, and filler are as follows: For example, relative to 100 parts by mass of the softener is, 50 to 150 parts by mass of the tackifier, and 50 to 150 parts by mass of the filler.

The vibration-damping composition is prepared as a kneaded material, by blending the above-described components in the above-described mixing ratio, and kneading with, for example, a kneader such as a mixing roll, pressure kneader, Banbury mixer, and extruder.

Thereafter, the produced kneaded material is rolled by, for example, calendering, extrusion molding, or press molding, to form the vibration-damping layer 2 into a sheet.

In this manner, the vibration-damping layer 2 is formed.

The vibration-damping layer 2 has a thickness of, for example, 0.5 to 6 mm, preferably 0.5 to 3 mm.

When the thickness of the vibration-damping layer 2 is below the above-described lower limit value, vibration-damping characteristics may be low. When the thickness of the vibration-damping layer 2 is more than the above-described upper limit value, although vibration-damping characteristics can be observed, effects of the increase in the thickness may hardly be observed.

The vibration-damping layer 2 has a glass transition temperature of, for example, 0° C. or less, preferably −20° C. or less, even more preferably −30° C. or less, and for example, −70° C. or more.

The glass transition temperature is obtained as a temperature at peak of shear loss modulus G″ measured with a dynamic viscoelasticity measuring apparatus using parallel plates as a tool under measurement conditions of the following: a sample thickness of 2.0 mm, a speed of temperature increase of 5° C./min, and a frequency of 1 Hz.

When the vibration-damping layer 2 has a glass transition temperature of more than the above-described upper limit value, pressure-adhesiveness of the vibration-damping layer 2 at normal temperature may be reduced, and furthermore, vibration-damping characteristics of the vibration-damping layer 2 at normal temperature may be reduced.

The vibration-damping layer 2 has a 90 degree peel pressure-adhesion at 23° C. of, for example, 10 N/25 mm or more, preferably 50 N/25 mm or more, even more preferably 95 N/25 mm or more, and for example, 500 N/25 mm or less.

The 90 degree peel pressure-adhesion is measured by preparing a sample by cutting the vibration-damping layer 2 into a size of a 25 mm width and a 100 mm length, bonding the sample to a stainless steel plate, and peeling the sample at 23° C. with an angle of 90 degree relative to the stainless steel plate at a speed of 300 mm/min using a universal tensile testing machine.

When the vibration-damping layer 2 has a 90 degree peel pressure-adhesion within the above-described range, the vibration-damping layer 2 has sufficient pressure-adhesiveness at a normal temperature.

The vibration-damping layer 2 has a volume resistivity of, for example, more than 1×10⁸ Ωcm, preferably 5×10⁸ Ωcm or more, even more preferably 1×10⁹ Ωcm or more, and for example, 1×10¹⁴ Ωcm or less. The volume resistivity is measured in conformity with the method described in ASTM D991.

The constraining layer 3 constrains the vibration-damping layer 2, and is laminated on the vibration-damping layer 2 to give tenacity to and to improve strength of the vibration-damping layer 2. The constraining layer 3 is formed into a sheet, is lightweight and thin, and formed from a material that can be in contact closely and integrally with the vibration-damping layer 2, for example, from glass fiber cloth, resin-impregnated glass fiber cloth, synthetic resin nonwoven fabric, metal foil, carbon fiber, and a synthetic resin film.

Glass fiber cloth is cloth made from glass fiber, and examples include known glass fiber cloth.

Examples of resin-impregnated glass fiber cloth include the above-described glass fiber cloth impregnated with synthetic resins such as a thermosetting resin and a thermoplastic resin, and include known resin-impregnated glass fiber cloth. Examples of thermosetting resins include epoxy resins, urethane resins, melamine resins, and phenol resins. Examples of thermoplastic resins include vinyl acetate resins, ethylene-vinyl acetate copolymers (EVA), vinyl chloride resins, and EVA-vinyl chloride resin copolymers. The above-described thermosetting resins and thermoplastic resins can be used singly, or can be used in combination.

Examples of synthetic resin non woven fabric include polypropylene resin nonwoven fabric, polyethylene resin nonwoven fabric, and polyester resin nonwoven fabric.

Examples of metal foil include aluminum foil and steel foil.

Carbon fiber is fiber mainly composed of carbon made into cloth, and known carbon fiber is used.

Examples of synthetic resin films include polyester films such as polyethylene terephthalate (PET) films, polyethylenenaphthalate (PEN) films, and polybutylene terephthalate (PBT) films.

Of these examples of the constraining layer 3, in view of adherence, strength, and costs, preferably, glass fiber cloth and metal foil are used.

The constraining layer 3 has a thickness of, for example, 0.05 to 2.0 mm, preferably 0.1 to 1.0 mm.

The total thickness of the vibration-damping layer 2 and the constraining layer 3 (that is, thickness of the vibration-damping sheet 1) is, for example, 0.55 to 8.0 mm

To produce the vibration-damping sheet 1, the vibration-damping layer 2 is bonded to the constraining layer 3 by, for example, compression bonding or thermocompression bonding.

In the vibration-damping sheet 1, on the other surface of the vibration-damping layer 2, i.e., the surface opposite to the surface where the constraining layer 3 is laminated, as necessary, a known releasing paper 4 can be bonded. In such a case, the releasing paper 4 is laminated on the vibration-damping layer 2 when the vibration-damping layer 2 is formed into a sheet.

The vibration-damping sheet 1 has a loss factor of, for example, 0.05 or more, preferably 0.10 or more, even more preferably 0.15 or more, and for example, 1.00 or less at 20° C., 40° C., and 60° C.

The loss factor of the vibration-damping sheet 1 at 80° C. is, for example, 0.03 or more, preferably 0.05 or more, even more preferably 0.1 or more, and for example, 1.00 or less.

The loss factor of the vibration-damping sheet 1 at 100° C. is, for example, 0.02 or more, preferably 0.03 or more, even more preferably 0.05 or more, and for example, 1.00 or less.

The loss factor is measured as follows. A sample is made by cutting the vibration-damping layer 2 into a size of a 10 mm width and a 250 mm length, and the sample is bonded to a SPCC steel plate of an adherend having a size of 0.8 mm×10 mm×250 mm. The loss factor is measured by the center excitation method using a loss factor measuring device at a frequency (e.g., 500 Hz) calculated from the resonance point.

When the loss factor of the vibration-damping sheet 1 is the above-described lower limit value or more, by bonding the vibration-damping sheet 1 to the vibrating member 5, the vibrating member 5 is sufficiently damped.

The thus obtained vibration-damping sheet 1 is bonded to various components used in the field of automobiles, railroad cars, home electric appliances, office equipment, household equipment, or working machinery, and those components are damped.

Examples of the various components include components used under high temperature of more than 40° C. (high temperature component); heat-generating components such as motor, heater, and engine; and components used under a wide range of temperature from, for example, normal temperature (20° C.) to high temperature (e.g., 100° C.).

To be more specific, in the vibration-damping sheet 1, when the releasing paper 4 is bonded to the surface of the vibration-damping layer 2, when in use, as shown by the phantom line in FIG. 1 (a), the releasing paper 4 is removed from surface of the vibration-damping layer 2, then, as shown in FIG. 1 (b), the surface of the vibration-damping layer 2 is bonded to the vibrating member 5 of a component as an adherend. In this manner, the vibration-damping sheet 1 damps vibration of the vibrating member 5.

The vibration-damping layer 2 can be bonded to the vibrating member 5 by, for example, thermocompression bonding.

The vibration-damping sheet 1 includes a vibration-damping layer 2 containing rubber and carbon black having an iodine adsorption number within a specific range in a specific mixing ratio.

To be more specific, the iodine adsorption number of carbon black within a specific range allows for sufficient ensuring of the specific surface area of carbon black. Therefore, the contact area of carbon black to rubber can be ensured sufficiently.

Assumingly, this causes an increase in the coefficient of friction between the rubber and carbon black, and conversion of vibration to heat. In this manner, when the vibrating member 5 vibrates, even if the vibration is transmitted the vibration-damping layer 2 of the vibration-damping sheet 1, the above-described conversion of vibration to heat allows the vibration-damping sheet 1 to absorb vibration, and this allows for damping vibration of the vibrating member 5.

Thus, by bonding the vibration-damping sheet 1 to the vibrating member 5, even if the vibrating member 5 is used under a wide range of temperature of a normal temperature to a high temperature, sufficient damping vibration can be achieved. To be specific, sufficient damping vibration can be achieved for the component used under normal temperature (20° C.) to high temperature of more than 40° C. to 100° C. or less.

In the embodiment of FIG. 1 (a) and FIG. 1 (b), in the vibration-damping sheet 1, the constraining layer 3 is laminated on the vibration-damping layer 2, but for example, although not shown, the vibration-damping sheet 1 can be formed to only include the vibration-damping layer 2 without providing the constraining layer 3.

Such an embodiment also achieves the same operations and effects as those of the embodiment of FIG. 1 (a) and FIG. 1 (b).

### EXAMPLES

In the following, the present invention is described in further detail with reference to Examples and Comparative Examples; however, the present invention is not limited thereto.

### Examples 1 to 4 and Comparative Examples 1 and 2

The components were blended in accordance with the formulation shown in Table 1, and the mixture was kneaded with a mixing roll, thereby preparing a kneaded material (vibration-damping composition).

Then, the obtained kneaded material was rolled into a sheet by press molding, thereby laminating the obtained kneaded material on the surface of the releasing paper and forming a vibration-damping layer having a thickness of 2.0 mm.

Thereafter, on the other side surface of the vibration-damping layer where the releasing paper was laminated, a constraining layer composed of glass fiber cloth having a thickness of 0.1 mm was bonded by thermocompression bonding, thereby producing a vibration-damping sheet having a thickness of 2.1 mm of the vibration-damping layer and the constraining layer in total.

Evaluation

### (1) Glass Transition Temperature

The shear loss modulus G″ of the vibration-damping layer was measured with a dynamic viscoelasticity measuring apparatus, and the temperature at the peak of the obtained shear loss modulus G″ was regarded as a glass transition temperature. The measurement conditions are shown below. The results are shown in Table 1.

Dynamic viscoelasticity measuring apparatus: ARES, manufactured by Rheometric Scientific, Inc.
Tool used: parallel plate
Sample thickness: 2.0 mm
Speed of temperature increase: 5° C./min

### Frequency: 1 Hz

### (2) 90 Degree Peel Adhesion

A vibration-damping sheet was cut into a size of a 25 mm width and a 100 mm length, thereby preparing a sample. The sample vibration-damping layer was disposed on the surface of a stainless steel plate (SUS304 steel plate), and compression bonded using a 2 kg roller. Thereafter, the vibration-damping sheet was peeled from the stainless steel plate at 23° C. using a universal tensile testing machine, thereby measuring a 90 degree peel adhesion at a peeling speed of 300 mm/min The results are shown in Table 1.

### (3) Vibration-Damping Characteristics (Loss Factor)

The loss factor of the vibration-damping sheet at 20° C., 40° C., 60° C., 80° C., and 100° C. was measured using a loss factor measuring device by center excitation method with the following measuring conditions. To be specific, the vibration-damping sheet was cut into a size of a 10 mm width and a 250 mm length, thereby preparing a sample. The sample was allowed to adhere to an adherend, and the loss factor was measured. The results are shown in Table 1.

Adherend: SPCC steel plate of 0.8 mm×10 mm×250 mm
Frequency: 500 Hz (500 Hz is calculated from resonance point)

### (4) Volume Resistivity

The volume resistivity of the vibration-damping layer was measured in conformity with ASTM D991. The results are shown in Table 1.

TABLE 1

| | | | Iodine adsorption | Examples and Comparative Examples | | | | | |
|---|---|---|---|---|---|---|---|---|---|
| | | | number | | | | | Comp. | Comp. |
| | | | (mg/g) | Ex. 1 | Ex. 2 | Ex. 3 | Ex. 4 | Ex. 1 | Ex. 2 |
| Mixing formulation of | Rubber | JSR butyl rubber 268 | | 100 | 100 | 100 | 100 | 100 | 100 |
| Vibration-damping | Carbon | Seast 3H | 84 | 100 | 50 | — | — | — | 25 |
| composition | black | Seast N | 70 | — | — | 100 | — | — | — |
| (parts by mass) | | Seast SO | 44 | — | — | — | 100 | — | — |
| | | Asahi #50 | 23 | — | — | — | — | 100 | — |
| | Mixing ratio of carbon black (mass %) | | | 19.9 | 11.1 | 19.9 | 19.9 | 19.9 | 5.9 |
| | (relative to vibration-damping composition) | | | | | | | | |
| | Softener | Polybutene HV 300 | | 100 | 100 | 100 | 100 | 100 | 100 |
| | Tackifier | Escorez 1202 | | 100 | 100 | 100 | 100 | 100 | 100 |
| | Filler | Calcium carbonate heavy | | 100 | 100 | 100 | 100 | 100 | 100 |
| | Antioxidant | Nocrac CD | | 2 | 2 | 2 | 2 | 2 | 2 |
| Evaluation | Vibration- | Glass transition temperature (° c.) | | −38 | −37 | −33 | −33 | −38 | −37 |
| | damping layer | 90 degree peel pressure-adhesion | | 100 | 90 | 140 | 110 | 110 | 90 |
| | | (n/25 mm) | | | | | | | |
| | | Volume resistivity (ωcm) | | 7 × 10⁸ | 2 × 10⁹ | 1 × 10¹⁰ | 2 × 10¹⁰ | 5 × 10¹⁴ | 3 × 10¹² |
| | Vibration- | Loss factor | 20° c. | 0.195 | 0.315 | 0.158 | 0.263 | 0.235 | 0.305 |
| | damping sheet | (500 Hz) | 40° c. | 0.340 | 0.325 | 0.270 | 0.298 | 0.195 | 0.170 |
| | | | 60° c. | 0.210 | 0.160 | 0.176 | 0.181 | 0.068 | 0.064 |
| | | | 80° c. | 0.116 | 0.056 | 0.087 | 0.085 | 0.028 | 0.030 |
| | | | 100° c. | 0.060 | 0.020 | 0.052 | 0.034 | 0.014 | 0.018 |

Abbreviations used in Table 1 are shown below.
JSR butyl 268: butyl rubber, degree of unsaturation 1.6, Mooney viscosity 51 (ML1 + 8, at 125° C.), manufactured by JSR CORPORATION
SEAST 3H: arithmetic average particle size 27 nm, HAF-HS grade, iodine adsorption number 84 mg/g (in conformity with JIS K6217-1 (2008)), manufactured by Tokai Carbon Co., Ltd.
SEAST N: arithmetic average particle size 29 nm, LI-HAF grade, iodine adsorption number 70 mg/g (in conformity with JIS K6217-1 (2008)), manufactured by Tokai Carbon Co., Ltd.
SEAST SO: arithmetic average particle size 43 nm, FEF grade, iodine adsorption number 44 mg/g (in conformity with JIS K6217-1 (2008)), manufactured by Tokai Carbon Co., Ltd.
Asahi #50: arithmetic average particle size 80 nm, iodine adsorption number 23 mg/g (in conformity with JIS K6217-1 (2008)), manufactured by Asahi Carbon Co., Ltd.
Polybutene HV300: liquid polybutene, kinetic viscosity 26000 mm²/s (at 40° C.), kinetic viscosity 590 mm²/s (at 100° C.), manufactured by Nippon Oil Corporation
Escorez 1202: petroleum resin, manufactured by Exxon Mobil Corporation
Calcium carbonate heavy: calcium carbonate, manufactured by Maruo calcium Co., Ltd.
NOCRAC CD: 4,4′-bis(α,α-dimethylbenzyl) diphenylamine, antioxidant, manufactured by OUCHI SHINKO CHEMICAL INDUSTRIAL CO., LTD.

While the illustrative embodiments of the present invention are provided in the above description, such is for illustrative purpose only and it is not to be construed as limiting in any manner. Modification and variation of the present invention that will be obvious to those skilled in the art is to be covered by the following claims.

### INDUSTRIAL APPLICABILITY

The vibration-damping sheet is used by bonding the vibration-damping sheet to a vibrating member used in various industrial products.

1. A vibration-damping sheet comprising a vibration-damping layer containing 100 parts by mass of rubber and 30 parts by mass or more of carbon black,
wherein the iodine adsorption number of the carbon black measured based on JIS K6217-1 (2008) “Part 1: Determination of iodine adsorption number (Titrimetric method)” is 30 mg/g or more.

2. The vibration-damping sheet according to claim 1, wherein 7 to 30 mass % of the carbon black is blended relative to the vibration-damping layer.

3. The vibration-damping sheet according to claim 1, wherein, when the thickness of the vibration-damping sheet is 2.0 mm, the vibration-damping layer has a glass transition temperature of 0° C. or less, the glass transition temperature being defined as a temperature at a peak of a shear loss modulus G″ measured by dynamic viscoelasticity measurement at a frequency of 1 Hz.

4. The vibration-damping sheet according to claim 1, wherein the vibration-damping sheet has a 90 degree peel pressure-adhesion of 10 N/25 mm or more when the vibration-damping sheet is bonded to a stainless steel plate and then peeled at 90 degree relative to the stainless steel plate at 23° C. and at a speed of 300 mm/min

5. The vibration-damping sheet according to claim 1, further comprising a constraining layer laminated on the vibration-damping layer.
